(19) United States
(12) Patent Application Publication
(10) Pub. No.: US 2024/0428777 A1
(43) Pub. Date: Dec. 26, 2024

(54) INTERACTION METHOD, APPARATUS, DEVICE, AND STORAGE MEDIUM

(71) Applicant: Beijing Zitiao Network Technology Co., Ltd., Beijing (CN)

(72) Inventors: Hanyang Cai, Beijing (CN); Sineng Tan, Beijing (CN)

(21) Appl. No.: 18/753,772

(22) Filed: Jun. 25, 2024

(30) Foreign Application Priority Data
Jun. 25, 2023 (CN) 202310755812.6

(51) Int. Cl. G10L 13/08; G10L 15/22

(52) U.S. Cl. CPC G10L 13/08; G10L 15/22

(57) ABSTRACT

According to embodiments of the present disclosure, an interaction method, apparatus, device and a storage medium are provided. The method includes: receiving at least one round of dialogue interaction between a user and a virtual object in a virtual scene, wherein the at least one round of dialogue interaction comprises selection of the user for a group of dialogue items provided in each round of dialogue interaction; and providing media content associated with the virtual object, the media content at least comprising a first audio portion corresponding to text content, wherein the text content is generated based on the at least one round of dialogue interaction. Thus, embodiments of the present disclosure can provide a user with corresponding media content created based on dialogue interaction with a virtual object in a virtual scene, thereby enriching user interaction experience in the virtual scene.

### FIELD

Example embodiments of the present disclosure generally relate to the field of computers, and in particular, to interaction methods, apparatuses, devices, and computer-readable storage media.

### BACKGROUND

With the development of computer level, various forms of electronic devices can greatly enrich people's daily lives. For example, some electronic devices may provide a user with a virtual scene, and such a virtual scene may include various types of characters, for example, a character that the user may control, or a non-player character (NPC).

In such a virtual scene, the user may, for example, control their own role to perform dialogue interaction with the non-player character. However, the interaction process of traditional dialogue interaction is generally fixed, which affects the user's interaction experience.

### SUMMARY

In a first aspect of the present disclosure, there is provided an interaction method. The method includes: receiving at least one round of dialogue interaction between a user and a virtual object in a virtual scene, wherein the at least one round of dialogue interaction comprises selection of the user for a group of dialogue items provided in each round of dialogue interaction; and providing media content associated with the virtual object, the media content at least comprising a first audio portion corresponding to text content, wherein the text content is generated based on the at least one round of dialogue interaction.

In a second aspect of the present disclosure, there is provided an interaction apparatus. The apparatus includes: a receiving module configured to receive at least one round of dialogue interaction between a user and a virtual object in a virtual scene, wherein the at least one round of dialogue interaction comprises selection of a group of dialogue items of the user provided in each round of dialogue interaction; and a providing module configured to provide media content associated with the virtual object, the media content at least comprising a first audio portion corresponding to text content, wherein the text content is generated based on the at least one round of dialogue interaction.

In a third aspect of the present disclosure, there is provided an electronic device. The device includes at least one processing unit; and coupled to the at least one processing unit and storing an instruction for being executed by the at least one processing unit, when executed by the at least one processing unit, the instruction causes the electronic device to implement the method of the first aspect.

In a fourth aspect of the present disclosure, a computer readable storage medium is provided, where the computer readable storage medium stores a computer program, and the computer program is executable by a processor to implement the method in the first aspect.

It should be appreciated that the content described in this section is not intended to limit critical features or essential features of the embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a flowchart of an example interaction process according to some embodiments of the disclosure;

FIG. 3A-FIG. 3E illustrate example interaction interfaces according to some embodiments of the disclosure;

FIG. 4 illustrates a schematic structural block diagram of an interaction apparatus according to some embodiments of the present disclosure;

FIG. 5 illustrates a block diagram of an electronic device in which various embodiments of the present disclosure can be implemented.

### DETAILED DESCRIPTION

The following will describe the embodiments of the present disclosure in more detail with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be noted that the title of any section/subsection provided herein are not limiting. Various embodiments are described throughout herein, and any type of embodiment may be included in any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive inclusion, that is, “including but not limited to”. The term “based on” should be understood as “based at least in part on.” The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data of a user, acquisition and/or use of data, etc. These aspects are in accordance with the corresponding laws and regulations and related provisions. In embodiments of the present disclosure, all data collection, acquisition, processing, forwarding, use and the like are carried out under the user's awareness and confirmation. Accordingly, when implementing the embodiments of the present disclosure, the user should be informed of the types of data or information that may be involved, a usage range, a usage scenario, and the like in an appropriate manner according to relevant laws and regulations, and then authorization of the user is obtained. The specific informing and/or authorization manner may vary according to actual situations and application scenarios, and the scope of the present disclosure is not limited in this aspect.

In the present description and the embodiments, the personal information processing is performed on the basis of legality (for example, obtaining the consent of the subject of the personal information or being necessary for the fulfillment of a contract, etc.), and is performed only within a predetermined range or a predetermined stipulation. The user rejects personal information other than the necessary information required for processing the basic function, and the use of the basic function by the user will not be affected.

Conventionally, some virtual scenes can support a variety of types of interactions between users and virtual objects (e.g., non-player characters) in the virtual scene. For example, a user may control a player role to perform dialogue interaction with a non-player character, for example, the user may select one dialogue item from a plurality of preset dialogue items to complete the dialogue interaction with the non-player character. However, such a dialogue interaction process generally involves preset content, and thus it is difficult for a user to obtain a dialogue interaction experience similar to that of a real person.

Embodiments of the present disclosure provide an interaction solution. According to various embodiments of the present disclosure, at least one round of dialogue interaction between a user and a virtual object in a virtual scene can be received, wherein the at least one round of dialogue interaction includes a selection of a group of dialogue items provided by the user in each round of dialogue interaction. Further, media content associated with the virtual object may be provided, and the media content includes at least a first audio portion corresponding to the text content, wherein the text content is generated based on at least one round of dialogue interaction.

Thus, embodiments of the present disclosure can provide a user with corresponding media content created based on dialogue interaction with a virtual object in a virtual scene, thereby enriching user interaction experience in the virtual scene.

### Example Environment

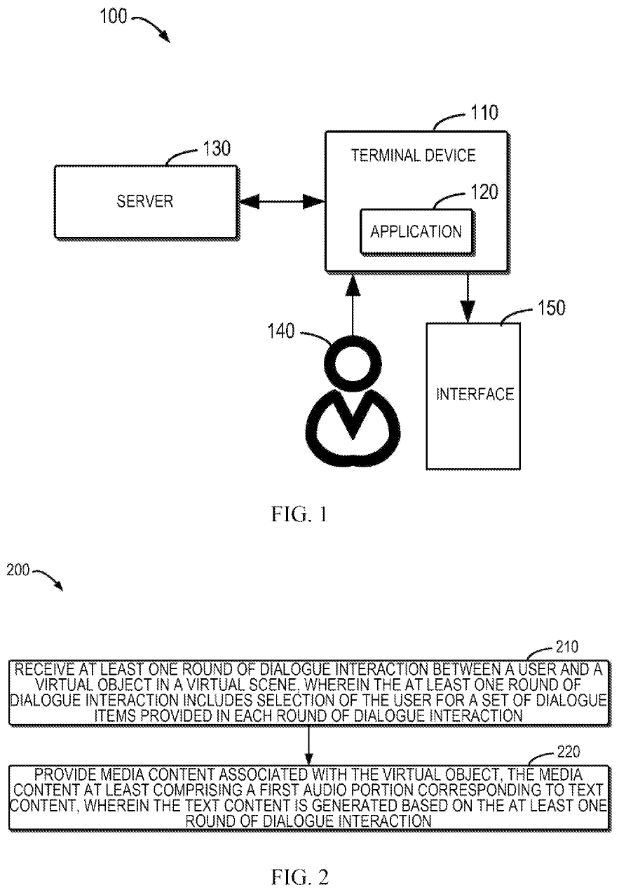

FIG. 1 illustrates a schematic diagram of an example environment 100 in which embodiments of the present disclosure can be implemented. As shown in FIG. 1, the example environment 100 may include a terminal device 110.

In this example environment 100, an application 120 that supports a virtual scene may be run on the terminal device 110. The application 120 may be any appropriate type of application for presenting a virtual scene, examples of which may include, but are not limited to, a simulation application, an emulation application, a game application, a virtual reality application, an augmented reality application, and so forth, which is not limited in the embodiments of the disclosure. A user 140 may interact with the application 120 via the terminal device 110 and/or its attached devices.

In the environment 100 of FIG. 1, if the application 120 is active, the terminal device 110 may present an interface 150 associated with a virtual scene through the application 120. At least one screen associated with the virtual scene may be presented in the interface 150. The at least one screen may include a screen associated with a virtual object corresponding to the current user, a screen associated with a virtual object corresponding to another user, a screen corresponding to a non-player character, a screen associated with a location in the virtual scene, etc. For example, the interface 150 may be a game application interface, so as to present a corresponding game scene. Alternatively, the interface 150 may also be another suitable type of interaction interface, which may support a user to control a virtual object in the interface to perform a corresponding action in the virtual scene.

In some embodiments, the terminal device 110 communicates with the server 130 to provide services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, personal navigation device, personal digital assistant (PDA), audio/video player, digital camera/camcorder, positioning device, television receiver, radio broadcast receiver, electronic book device, game device, or any combination of the above, including accessories and peripherals of these devices, or any combination thereof. In some embodiments, the terminal device 110 can also support any type of user-specific interface (such as ‘wearable’ circuitry, etc.).

The server 130 may be an independent physical server, or may be a server cluster or a distributed system formed by a plurality of physical servers, or may also be a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the virtual scene-supported application 120 in the terminal device 110.

Communication connection may be established between the server 130 and the terminal device 110. The communication connection may be established in a wired manner or a wireless manner. The communication connection may include, but are not limited to, Bluetooth connection, mobile network connection, Universal Serial Bus (USB) connection, Wireless Fidelity (WiFi) connection, and the like, to which embodiments of the present disclosure are not limited. In an embodiment of the present disclosure, the server 130 and the terminal device 110 may achieve signaling interaction through communication connection therebetween.

It should be understood that the structure and function of the various elements in environment 100 are described for illustration only, and are not intended to imply any limitation on the scope of the disclosure.

### Example Processes

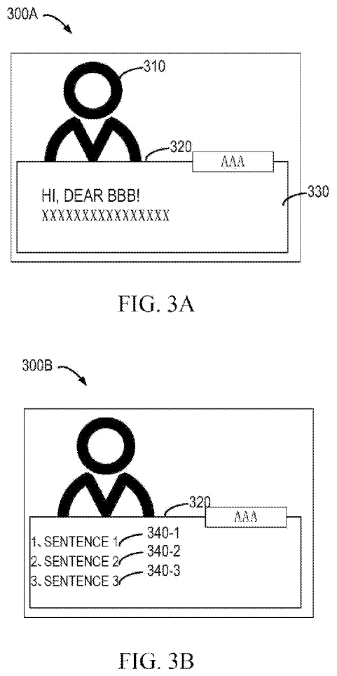

FIG. 2 illustrates a flowchart of an interaction process 200 according to some embodiments of the disclosure. The process 200 may be implemented at the terminal device 110. For ease of discussion, the process 200 will be described with reference to the environment 100 of FIG. 1.

At block 210, the terminal device 110 receives at least one round of dialogue interaction between a user and a virtual object in a virtual scene, wherein the at least one round of dialogue interaction comprises selection of the user for a group of dialogue items provided in each round of dialogue interaction.

In some embodiments, the virtual scene may include, for example, a game scene, a simulation scene, a virtual reality scene, and any suitable type of virtual function. In some embodiments, the virtual object may include an appropriate interactable object provided in the virtual scene, e.g., non-player character.

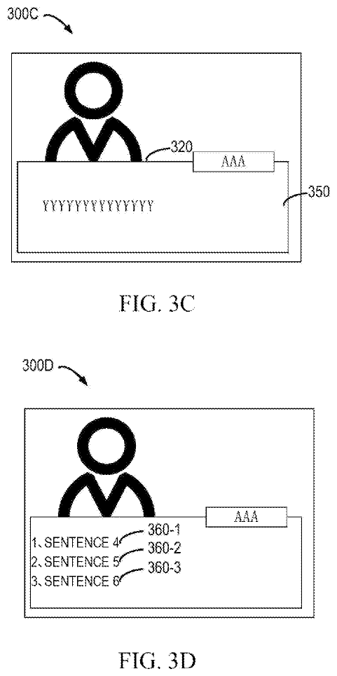

The specific process of block 210 will be described below in conjunction with FIG. 3A to FIG. 3E. It should be understood that although FIG. 3A to FIG. 3E depict the game scenario as an example, it is merely illustration.

As shown in FIG. 3A, the terminal device 110 may, for example, present an interface 300A, and the interface 300A may be used to present relevant information of a virtual scene (e.g., a game scene). For example, the interface 300A can include a virtual object 310, e.g., a non-player character in the virtual scene.

Further, the terminal device 110 may also provide a dialogue control 320 to support dialogue interaction between the user and the virtual object 310. For example, such dialogue control 320 may be provided based on a dialogue request between the user and the virtual object. Alternatively, such dialogue control 320 may also be automatically provided in the virtual scene based on a particular triggering condition being satisfied, such triggering condition may include, but is not limited to, any suitable plot condition, an associated temporal condition in the virtual scene, a character condition corresponding to a player character in the virtual scene, and so forth.

As shown in FIG. 3A, in the dialogue control 320, the terminal device 110 may present a first sentence 330 provided by the virtual object 310. It should be understood that, although the first sentence 330 is provided by means of text in FIG. 3A, the first sentence 330 may also be provided to the user by means as audio, video, etc.

Further, after the first sentence 330 is provided for a preset length of time or after receiving a preset operation from the user, the terminal device 110 may provide a group of dialogue items 340-1 to 340-3 (individually or collectively referred to as dialogue item 340) as illustrated in FIG. 3B. Such a group of dialogue items 340 may indicate a candidate reply to the first sentence 330 provided by the virtual object 310.

Further, the terminal device 110 may receive a selection of the user for one or more dialogue items in the group of dialogue items 340, thereby completing a round of dialogue interaction with the virtual object 310.

Additionally, it should be appreciated that in some scenarios, the dialogue may also be initiated by the user. That is, the user may initiate dialogue interaction with the virtual object 310, for example, by selecting one dialogue item from a plurality of dialogue items.

Thus, a round of dialogue interaction may always include a dialogue item selected by the user and a sentence provided by the virtual object. This may include the user selecting a dialogue item and the virtual object providing a reply sentence based on the dialogue item. Alternatively, the virtual object may provide a query sentence and the user may select a dialogue item as a reply sentence

By taking FIG. 3A and FIG. 3B as an example, the dialogue interaction process shown in FIG. 3A and FIG. 3B may be taken as a round of dialogue interaction.

In some embodiments, the user may also perform a plurality of rounds of dialogue interactions with the virtual object 310. For example, in the interface 300C, the virtual object 310 may for example further provide a second sentence 350, as illustrated in FIG. 3C. Similarly, after the second sentence 350 is provided for a preset length of time or after receiving a preset operation from the user, the terminal device 110 may provide a group of dialogue items 360-1 to 360-3 (individually or collectively referred to as the dialogue item 360) as illustrated in FIG. 3D. Such a group of dialogue items 360 may indicate a candidate reply to the second sentence 350 provided by the virtual object 310.

Further, the terminal device 110 may receive a selection of the user for one or more dialogue item in the group of dialogue items 360, thereby completing a second round of dialogue interaction with the virtual object 310.

It should be understood that such a dialogue interaction process may be performed for a predetermined number of rounds, and the number may be a preset number, or may be determined based on a dialogue item selected by the user.

The basic interaction flow of the dialogue interaction is introduced above, and the sentence provided by the virtual object and the generation process of the dialogue item will be introduced below. It should be appreciated that the generating process may be performed by a suitable generating device (e.g., the terminal device 110, the server 130, and/or other suitable electronic devices or combinations in FIG. 1).

In some embodiments, the first sentence 330 used to start dialogue interaction and/or the set of dialogue items used to start dialogue interaction may include preset content. For example, taking a non-player character as an example, different users may obtain the same first statement 330 and/or dialogue item when start to interact with the same non-player character in the virtual scene.

Alternatively, the generating device may also generate the first statement 330 and/or a corresponding dialogue item, e.g., based on at least one piece of description information associated with the user in the virtual scene (e.g., in a case that a user selects a dialogue item to trigger dialogue interaction). For example, the generating device may generate a corresponding first sentence 330 and/or dialogue item based on information of a player character controlled by the user (e.g., name, personality, occupation, etc.).

Alternatively, or additionally, the generating device may also generate the first statement 330 and/or the dialogue item based on the historical interaction between the user and the virtual object. Such historical interaction may include a historical dialogue interaction, or another types of interaction in the virtual scene (e.g., combat interaction, team interaction, deal interaction, etc.).

In this way, the embodiments of the present disclosure can provide more personalized dialogue interaction for different users, thereby improving the interaction experience of the users.

Further, for a plurality of rounds of dialogue interaction, the dialogue interaction result of a previous round may also be used for guiding generation of a sentence and/or a dialogue item in the next round of dialogue. For example, by taking FIG. 3B as an example, if the user selects the dialogue item 340-1, the generating device may generate a second sentence 350 and/or a group of dialogue items 360 for the second sentence as shown in FIG. 3C based on the selected dialogue item 340-1.

In some embodiments, each group of dialogue items provided in the plurality of rounds of dialogue interaction may include a plurality of dialogue items corresponding to different preset styles. By taking FIG. 3B and FIG. 3D as examples, dialogue items 340-1, 340-2, and 340-3 may correspond to different styles, and dialogue items 360-1, 360-2, and 360-3 may correspond to different styles.

For example, such styles may include different dialogue styles (e.g., gentle, grandiose, etc.), or personality styles corresponding to characters controlled by users (e.g., kind, neutral, evil, etc.). Such style information may, for example, be provided to the generating device as a guide for generating the dialogue item 340 and/or the object item 360.

In some embodiments, in order to enrich the experience of the dialogue interaction, the generating device may also generate a sentence and a dialogue item in the dialogue interaction according to preset rhythm rule, for example. For example, the first sentence 330, the group of dialogue items 340, the second sentence 350, and the second dialogue items 360 may have the same rhythm.

In some embodiments, the generating device may generate sentences and dialogue items in dialogue interaction by e.g., using an appropriate generative model. Such a generative model may include, for example, any suitable machine learning model to process input information according to the process discussed above so as to generate corresponding sentences and/or dialogue items. The present disclosure is not intended to limit the specific structure and types of generative models.

It should be appreciated that the dialogue interaction discussed above may last for one or more rounds.

Continuously referring to FIG. 2, at block 220, the terminal device 110 provides media content associated with the virtual object, the media content including at least a first audio portion corresponding to text content, wherein the text content is generated based on the at least one round of dialogue interaction.

As shown in FIG. 3E, the terminal device 110 may, for example, provide the user with audio content 370 (e.g., a song) created based on at least one round of dialogue interaction. Such audio content 370 may include, for example, a chanting portion (i.e., a first audio portion) corresponding to lyrics content (i.e., text content) of a song.

Alternatively, or additionally, such audio content 370 may also include a second audio portion corresponding to melody content of a song. That is, the terminal device 110 may, for example, provide the user with a song generated based on the dialogue interaction, which includes the chanting of lyrics and a background melody.

In some other examples, the media content may also include, for example, video content, which may include an audio portion and a picture portion as introduced above. For example, the picture portion may include a set of static pictures or dynamic pictures characterizing the historical interaction of an object controlled by the user in the virtual scene.

A process of generating media content is described in detail below.

In some embodiments, the generating device discussed above may generate text content (e.g., the lyrics content) based on at least one round of dialogue interaction between the user and the virtual object. Such text content may, for example, be generated to have a preset rhythm rule so that the generated text content is of a form similar to poem content.

In some embodiments, the generating device may also generate the text content, for example, based on at least one piece of description information associated with the user in the virtual scene as discussed above and/or the historical interaction between the user and the virtual object.

Further, the generating device may obtain corresponding chanting content according to the generated text content. In some embodiments, the generating device may, for example, utilize an audio generative model to convert the text content into audio content, thereby generating the corresponding chanting content.

In other embodiments, in order to increase speed of generating the chanting content, the generating device may, for example, build a preset chanting content library in advance, and obtain the chanting content matching the generated text content from the library.

By way of example, the generating device may, for example, traverse all possible dialogue interaction scenarios with the virtual object, and convert the text content generated in the respective dialogue interaction scenarios into the chanting content in offline manner. During the real-time processing, the generating device may perform text matching and/or semantic matching, for example, based on the currently generated text content, so as to obtain the matched chanting content from the chanting content library.

In this way, the embodiments of the present disclosure may increase the rendering speed of the corresponding chanting content while ensuring the personalization of the text content, and thus avoid affecting the user's interactive experience due to the generation speed of the chanting content.

In some embodiments, in a case that the media content also includes an audio portion corresponding to the melody content, the generating device may generate the first melody content in real-time based on the text content. For example, the generating device may utilize an appropriate melody generative model to generate a corresponding melody (e.g., melody of song) from text content (e.g., lyrics).

In still other embodiments, to improve the timeliness of the user interactions, the generating device may also, for example, select particular melody content from a preset melody library for generating media content. For example, the generating device may select the corresponding melody content according to the style information indicated in at least one round of dialogue interaction. For example, in a case that the character style of the feature represented by the dialogue item selected by the user is “kind”, the generating device may select the melody content matching “kind” for generating the media content.

In some embodiments, the dialogue interaction between the user and the virtual object may be appropriately managed so as to be used in the next dialogue interaction process. For example, the text content (e.g., sentence and selected dialogue item) itself corresponding to such dialogue interaction, a keyword in the text content, or a summary of the text content, etc., may be stored for the next dialogue interaction process with the virtual object. In this way, the virtual object may be presented with memory capabilities, thereby improving the interaction experience of the user.

### Example Apparatus and Devices

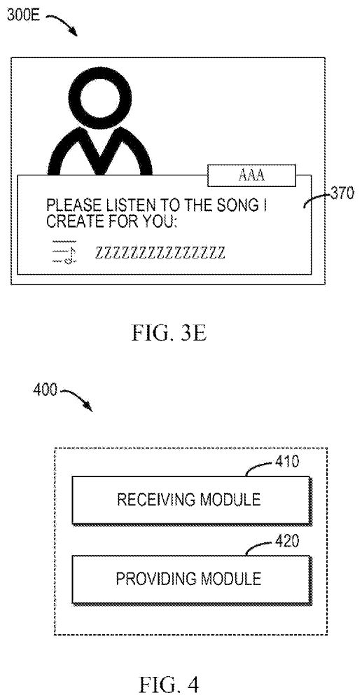

Embodiments of the present disclosure also provide corresponding apparatus for implementing the methods or processes described above. FIG. 4 illustrates a schematic structural block diagram of a content generation apparatus 400 according to certain embodiments of the present disclosure. The apparatus 400 may be implemented as or included in a terminal device 110 as discussed above. The various modules/components in the apparatus 400 may be implemented by hardware, software, firmware, or any combination thereof.

As shown in FIG. 4, the apparatus 400 comprises a receiving module 410 configured to receive at least one round of dialogue interaction between a user and a virtual object in a virtual scene, wherein the at least one round of dialogue interaction comprises selection of a group of dialogue items of the user provided in each round of dialogue interaction; and a providing module 420 configured to provide media content associated with the virtual object, the media content at least including a first audio portion corresponding to text content, wherein the text content is generated based on the at least one round of dialogue interaction.

In some embodiments, the media content also includes a second audio portion corresponding to melody content.

In some embodiments, the melody content includes first melody content generated based on the text content, or second melody content selected from a preset library of melodies.

In some embodiments, the at least one round of dialogue interaction at least includes a first round of dialogue interaction and a second round of dialogue interaction; the first round of dialogue interaction includes: controlling the virtual object to provide a first sentence, and receiving a selection of the user for a first dialogue item in a first group of dialogue items, the first dialogue item indicating a candidate reply to the first sentence; and a second round of dialogue interaction includes: controlling the virtual object to provide a second sentence, and receiving a second selection of the user for a second dialogue item in a second group of dialogue items, the second dialogue item indicating a candidate reply to the second sentence.

In some embodiments, the second sentence and/or the second group of dialogue items are generated based on the selected first dialogue item in the first group of dialogue items.

In some embodiments, the first round of dialogue items or the second round of dialogue items comprises a plurality of dialogue items, and each dialogue item of the plurality of dialogue items corresponds to a different preset style.

In some embodiments, the first audio portion includes chanting content associated with the text content.

In some embodiments, the chanting content includes a target chanting content selected from a preset chanting content library and matching the text content.

In some embodiments, the chanting content is generated by converting the text content into audio content.

In some embodiments, the at least one round of dialogue interaction includes a plurality of rounds of dialogue interaction, and a plurality of groups of dialogue items corresponding to the plurality of rounds of dialogue interaction are generated based on a preset rhythm rule.

In some embodiments, the group of dialogue items provided in each round of dialogue interaction is further generated based on a historical interaction between the user and a target object and/or at least one piece of description information associated with the user in the virtual scene.

The units included in apparatus 400 may be implemented in a variety of ways, including software, hardware, firmware, or any combination thereof. In some embodiments, one or more units may be implemented using software and/or firmware, such as machine-executable instructions stored on a storage medium. In addition to or instead of machine-executable instructions, some or all of the units in apparatus 400 may be implemented, at least in part, by one or more hardware logic components. By way of example, and not limitation, exemplary types of hardware logic components that can be used include Field Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

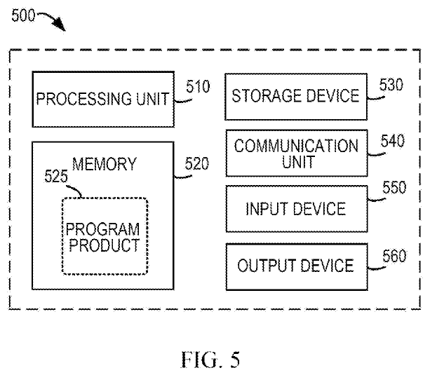

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the terminal device 110 shown in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, so as to improve the parallel processing capability of the electronic device 500.

The electronic device 500 typically includes a number of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data (e.g., training data for training) and that can be accessed within the electronic device 500.

The electronic device 500 may further include additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. An interaction method, comprising:
receiving at least one round of dialogue interaction between a user and a virtual object in a virtual scene, wherein the at least one round of dialogue interaction comprises selection of the user for a set of dialogue items provided in each round of dialogue interaction; and
providing media content associated with the virtual object, the media content at least comprising a first audio portion corresponding to text content, wherein the text content is generated based on the at least one round of dialogue interaction.

2. The method of claim 1, wherein the media content further comprises a second audio portion corresponding to melody content.

3. The method of claim 2, wherein the melody content comprises:
first melody content generated based on the text content; or
second melody content selected from a preset melody library.

4. The method of claim 1, wherein the at least one round of dialogue interaction at least comprises a first round of dialogue interaction and a second round of dialogue interaction,
the first round of dialogue interaction comprises: controlling the virtual object to provide a first sentence, and receiving a selection of the user for a first dialogue item in a first set of dialogue items, the first dialogue item indicating a candidate reply to the first sentence,
the second round of dialogue interaction comprises: controlling the virtual object to provide a second sentence, and receiving a second selection of the user for a second dialogue item in a second set of dialogue items, the second dialogue item indicating a candidate reply to the second sentence,
wherein the second sentence and/or the second set of dialogue items are generated based on the selected first dialogue item in the first set of dialogue items.

5. The method of claim 4, wherein the first round of dialogue items or the second round of dialogue items comprises a plurality of dialogue items, and each dialogue item of the plurality of dialogue items corresponds to a different preset style.

6. The method of claim 1, wherein the first audio portion comprises chanting content associated with the text content.

7. The method of claim 6, wherein the chanting content comprises a target chanting content selected from a preset chanting content library and matching the text content.

8. The method of claim 6, wherein the chanting content is generated by converting the text content into audio content.

9. The method of claim 1, wherein the at least one round of dialogue interaction comprises a plurality of rounds of dialogue interaction, and a plurality of sets of dialogue items corresponding to the plurality of rounds of dialogue interaction are generated based on a preset rhythm rule.

10. The method of claim 1, wherein the set of dialogue items provided in each round of dialogue interaction is further generated based on a historical interaction between the user and a target object and/or at least one piece of description information associated with the user in the virtual scene.

11. An electronic device, comprising:
at least one processing unit; and
at least one memory coupled to the at least one processing unit and storing an instruction for being executed by the at least one processing unit, when executed by the at least one processing unit, the instruction causes the electronic device to implement an interaction method comprising:
receiving at least one round of dialogue interaction between a user and a virtual object in a virtual scene, wherein the at least one round of dialogue interaction comprises selection of the user for a set of dialogue items provided in each round of dialogue interaction; and
providing media content associated with the virtual object, the media content at least comprising a first audio portion corresponding to text content, wherein the text content is generated based on the at least one round of dialogue interaction.

12. The electronic device of claim 11, wherein the media content further comprises a second audio portion corresponding to melody content.

13. The electronic device of claim 12, wherein the melody content comprises:
first melody content generated based on the text content; or
second melody content selected from a preset melody library.

14. The electronic device of claim 11, wherein the at least one round of dialogue interaction at least comprises a first round of dialogue interaction and a second round of dialogue interaction,
the first round of dialogue interaction comprises: controlling the virtual object to provide a first sentence, and receiving a selection of the user for a first dialogue item in a first set of dialogue items, the first dialogue item indicating a candidate reply to the first sentence,
the second round of dialogue interaction comprises: controlling the virtual object to provide a second sentence, and receiving a second selection of the user for a second dialogue item in a second set of dialogue items, the second dialogue item indicating a candidate reply to the second sentence,
wherein the second sentence and/or the second set of dialogue items are generated based on the selected first dialogue item in the first set of dialogue items.

15. The electronic device of claim 14, wherein the first round of dialogue items or the second round of dialogue items comprises a plurality of dialogue items, and each dialogue item of the plurality of dialogue items corresponds to a different preset style.

16. The electronic device of claim 11, wherein the first audio portion comprises chanting content associated with the text content.

17. The electronic device of claim 16, wherein the chanting content comprises a target chanting content selected from a preset chanting content library and matching the text content.

18. The electronic device of claim 16, wherein the chanting content is generated by converting the text content into audio content.

19. The electronic device of claim 11, wherein the at least one round of dialogue interaction comprises a plurality of rounds of dialogue interaction, and a plurality of sets of dialogue items corresponding to the plurality of rounds of dialogue interaction are generated based on a preset rhythm rule.

20. A computer readable storage medium having stored thereon a computer program which, when being executed by a processor, implements an interaction method comprising:
receiving at least one round of dialogue interaction between a user and a virtual object in a virtual scene, wherein the at least one round of dialogue interaction comprises selection of the user for a set of dialogue items provided in each round of dialogue interaction; and
providing media content associated with the virtual object, the media content at least comprising a first audio portion corresponding to text content, wherein the text content is generated based on the at least one round of dialogue interaction.
